(19) United States
(12) Patent Application Publication
(10) Pub. No.: US 2002/0032671 A1
(43) Pub. Date: Mar. 14, 2002

(54) File system and file caching method in the same

(76) Inventor: Tetsuya Iinuma, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 09/797,826

(22) Filed: Mar. 5, 2001

(30) Foreign Application Priority Data
Sep. 12, 2000 (JP) P2000-275887

(51) Int. Cl. G06F 17/30; G06F 12/00

(52) U.S. Cl. 707/1; 707/200; 707/10; 711/118; 707/205

(57) ABSTRACT

A file system that reads a file, in response to a request from a user, from an external storage, transfers the read file to the user, and also stores a copy of the read file in a cache memory in consideration of the file's frequency in access so that the cache hit ratio may be improved. In response to a following request for the file stored in both the memory and the external storage, the file system transfers, to the user, the copy file stored in the memory instead of the file stored in the external storage in order to speed up the file access processing. The file system ejects a file having the least access count among the files stored in the memory when there is no space for storing the copy file in the memory.

### FIELD OF THE INVENTION

The present invention relates to a file system, which reads, from an external storage, a file designated by a user and supplies the file to the user. The present invention, more particularly, relates to a file system, which stores some files, each having a high frequency in use, so that a user may access a designated file more quickly on average.

### BACKGROUND AND MATERIAL INFORMATION

In a file system of a conventional computer, a file read in units of data block from an external storage is temporarily preserved (cached) also in the memory (cache memory) in the computer in units of data block in order to speed up access (mainly reading process) to a file stored in the external storage such as a magnetic disk unit.

A data block to be accessed is cached in a readable memory. When access to the same data block is required, it can be processed in the computer. By doing this, the overhead required for reaccess to the external storage can be reduced. When file access to the external storage by a user is biased, caching is particularly effective.

However, the same data block cannot be preserved eternally because the capacity of the cache memory is limited. Consequently, There may be a case where new access to a file being not preserved in the cache memory is generated If there is no space for fetching all the data blocks of the file in the cache memory, the file system ejects data blocks in sequence of time in the cache memory into the external storage, thus prepares a space in the cache area. This is a renewal method of the cache memory, which is called Least Recently Used (LRU).

In this case, the data block written by a user does not exist other than in the cache memory at that point of time. So it is written in to the external storage in specific timing so as to hold the consistency of data.

However, in a file system for executing cache management according to the LRU system, even a data block of a high access frequency may be often ejected from the cache memory.

Such a condition is easily caused when the capacity of cache memory is small or the access to a file stored in the external storage is little biased. As an example of the latter, a case of a Web server may be cited. Namely, the Web server receives a hypertext transfer protocol (HTTP) request from a plurality of clients connected via a network, reads the designated files, and transmits them to the clients. In this case, a plurality of clients may access the same file frequently or repeatedly.

FIG. 8 is a drawing for explaining the cache managing method by the LRU system. In this case, it is assumed that the cache memory has three slots for storing one block of data and the files A, B, C, and D to be accessed are composed of one block respectively. Further, the access pattern to a file stored in the external storage by a user is assumed as: A→B→C→A→A→B→D→A→B→C→D→A

The file system sequentially reads the files A, B, and C from the external storage according to the access pattern, supplies them to a user, and sequentially caches the files A, B, and C in the three free slots in the cache memory (Steps S800, S801, S802). An access request to the file A is given continuously and the file A is cached (indicated by the underline in FIG. 8) at this time. So the file system reads the file A from the cache memory and supplies it to the user (Steps S803, S804).

Furthermore, an access request to the file D is given and the file system reads the file D from the external storage, supplies it to the user, ejects the oldest file A, and caches the file D (Step S805). Hereinafter, in the same way, when a file request is given, the file system reads the concerned file from the external storage, supplies it to the user, and caches it instead of the oldest file (Steps S806 to S810).

In this case, although the access count to each file at S809 is, for example, 4 times for A, 3 times for B, 2 times for C, and 2 times for D, the cached files are B, C, and D and the file A having a largest access count is ejected from the cache memory. Further, at S810, although the access count (3 times) of the file B is larger than that (2 times) of the files C and D, the file B is ejected from the cache memory.

As mentioned above, in the conventional caching method using the LRU system, the access count to a file is not considered with respect to renewal of the cache memory. Therefore, when an access request to a file is often given like the aforementioned HTTP request, the cache memory is renewed frequently and disk access is frequently given for loading data into the cache memory, causing a large overhead.

The present invention was developed with the foregoing in view and is intended to provide a file system for executing cache management in response to the access count to a file so as to improve the cache hit ratio and additionally realizing speedup of file access.

### SUMMARY OF THE INVENTION

Accordingly, the present invention is directed to a file system and a file caching method in the file system that substantially obviates one or more of problems due to limitations and disadvantages of the prior art.

In accordance with the purpose of the present invention, as embodied and broadly described, the present invention is directed to a file system which reads a file from an external storage in response to a request from a user and transfers the read file to the user. The file system comprises means for receiving the request from the user and transferring the read file to the user, means for reading the requested file from the external storage, a memory, a file manager which provides the read file to the receiving/transferring means and stores the read file in the memory in units of file, a table, and a table manager which records, in the table, an access count to each file stored in the memory. The file manager, when a requested file is stored in the memory at the time of being received the request, reads the requested file from the memory and provides it to the receiving/transferring means, and, when there is no space for storing the read file in the memory, ejects a file having the least access count among the files stored in the memory.

### BRIEF DESCRIPTION OF THE DRAWINGS

The accompanying drawings, which are incorporated in and constitute part of this specification, illustrate various embodiments and/or features of the invention and together with the description, serve to explain the principles of the invention. In the drawings:

FIG. 1 is a block diagram showing the constitution of a file system consistent with the present invention;

FIG. 2 is a drawing showing an example of the cache management table shown in FIG. 1.

FIG. 3 is a flow chart showing the cache managing method;

FIG. 4 is a drawing for explaining the cache managing method;

FIG. 5 is a flow chart showing the first embodiment of the cache managing method;

FIG. 6 is a flow chart showing the second embodiment of the cache managing method;

FIG. 7 is a flow chart showing the third embodiment of the cache managing method; and

FIG. 8 is a drawing for explaining the cache managing method using the LRU system.

### DETAILED DESCRIPTION

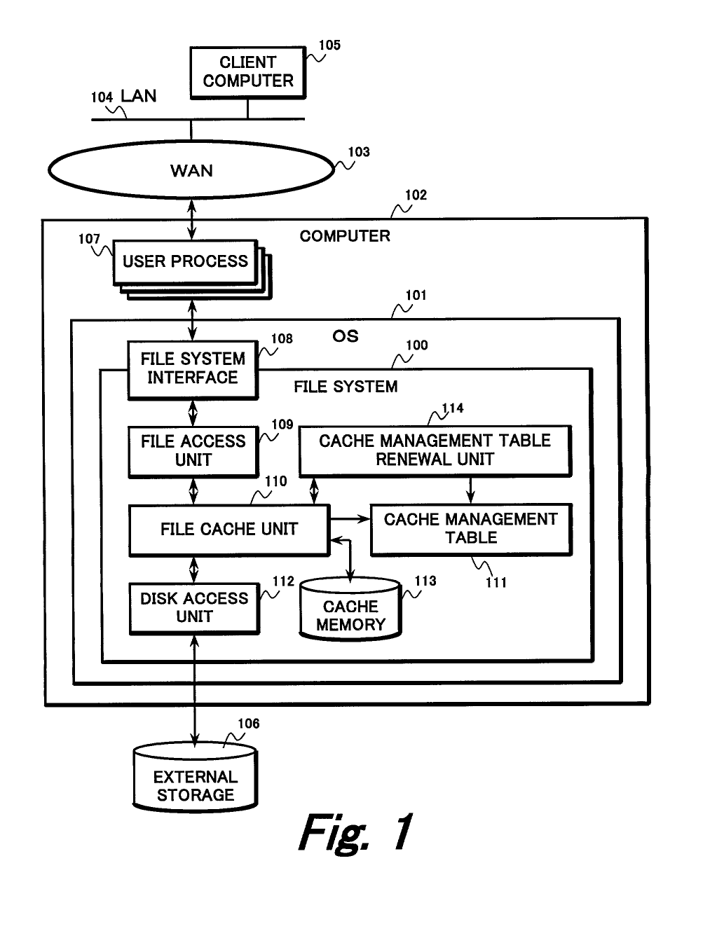

The embodiments of the present invention will be explained hereunder with reference to the accompanying drawings. FIG. 1 is a block diagram showing the constitution of a file system relating to an embodiment of the present invention. A file system 100 is involved in an operating system (OS) 101 inside a computer 102.

The computer 102 is connected to a client computer 105 via a wide area network (WAN) 103 or a local area network (LAN) 104 and functions, for example, as a WEB server. The computer 102 is connected to an external storage 106 such as a magnetic disk unit and stores various data files and management information thereof, for example, file name, file capacity, etc.

A user operates the client computer 105, accesses the computer 102, designates, for example, a file name, and requests reading of the desired file. In this case, a user process relating to file reading is started in the computer 102 and the user process 107 issues an access request to a desired file stored in the external storage 106 to the file system 100.

In this case, the user process 107 is started according to application software (not shown in the drawing) installed in the computer 102 and the computer 102 may install a plurality of different types of application software.

The file system 100 has a file system interface 108, a file access unit 109, a file cache unit 110, a cache management table 111, a disk access unit 112, a cache memory 113, and a cache management table renewal unit 114.

The file system interface 108 is an interface between the file system 100 and the OS 101. The file access unit 109 receives a request from the user process 107 via the file system interface 108 and calls the file cache unit 110 so as to let it operate.

The file cache unit 110 determines whether a file desired by a user is cached or not by referring to the cache management table 111, reads or writes into a file from the cache memory 113, and further instructs the cache management table renewal unit 114 to renew the cache management table 111.

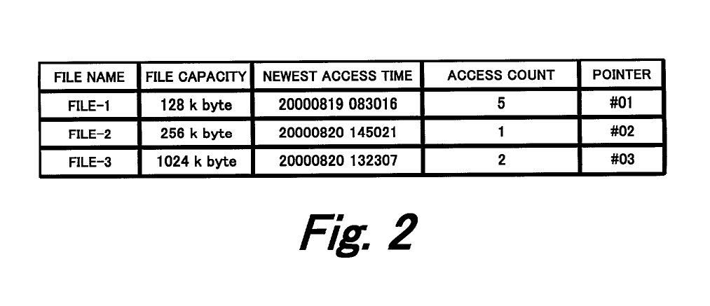

The cache management table 111, like an example shown in FIG. 2, stores the name of each file preserved in the cache memory 113, property information concerning each file, for example, the storage position (pointer) of each file in the cache memory 113, file capacity, access count from a user, and newest access time.

The disk access unit 112 actually reads a file from or writes a file into the external storage 106. The cache memory 113 is a memory for preserving files read from the external storage. The cache management table renewal unit 114 properly renews the property information in the cache management table 111 such as the access count, newest access time, etc.

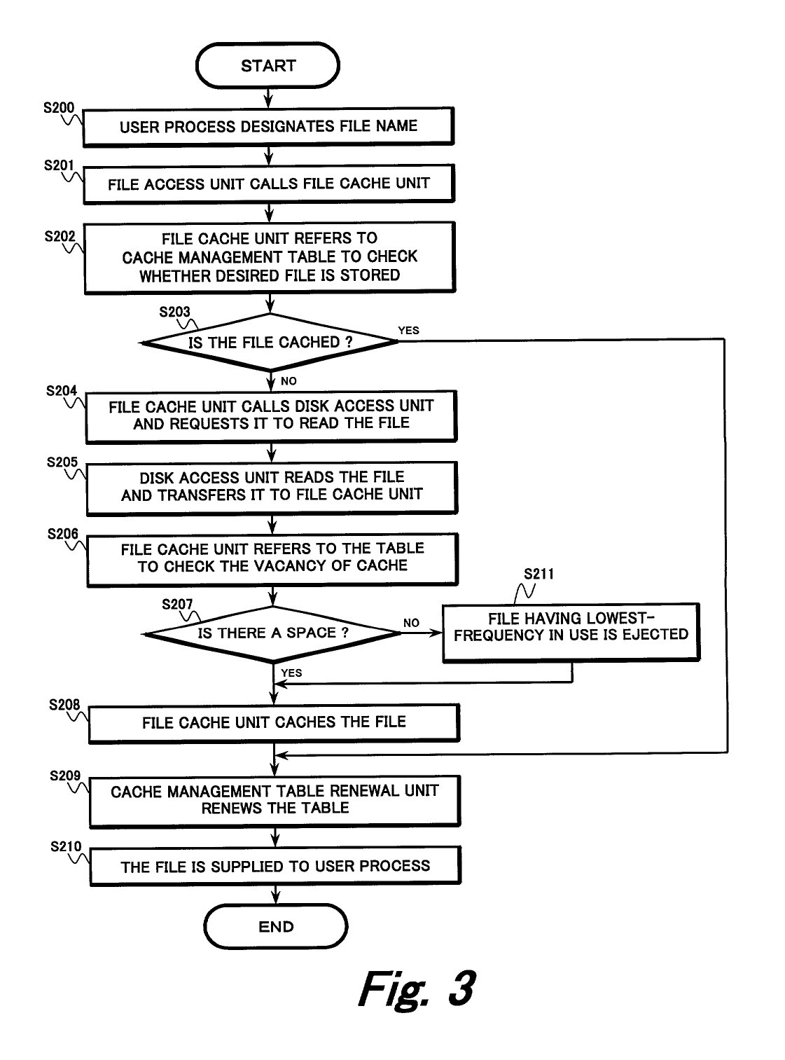

Next, the internal operation of the file system 100 will be explained by referring to FIG. 3. FIG. 3 is a flow chart showing the operation of the file system relating to this embodiment.

The user process 107 designates the file name desired by a user and accesses the file system 100 (Step S200). The file access unit 109 receiving it via the file access interface 108 calls the file cache unit 110 (Step S201).

The file cache unit 110 refers to the cache management table 111 by a key of the file name and checks whether the desired file is preserved in the cache memory 113 (Step S202).

When the desired file is not cached (Step S203), the file cache unit 110 calls the disk access unit 112 and requests reading of the concerned desired file (Step S204) The disk access unit 112 reads the concerned desired file and attached management information from the external storage 106 by a key of the file name and transfers it to the file cache unit 110 (Step S205).

The file cache unit 110 refers to the cache management table 111 with reference to the capacity of the concerned desired file and ascertains the free condition of the cache memory 113 (Step S206).

When there is a space in the cache memory 113 (Step S207), the file cache unit 110 writes the concerned desired file read from the external storage 106 into the cache memory 113 (Step S208), calls the cache management table renewal unit 114, and instructs it to renew the cache management table 111 and upon receipt of it, the cache management renewal unit 114 renews the last access time relating to the concerned desired file and increments the access count (Step S209).

Thereafter, the concerned desired file is supplied to the user process via the file cache unit 113, the file access unit 109, and the file system interface 108 (Step S210). In this case, as an example, the storage process of the desired file into the cache memory 113 is executed earlier than the supply of the desired file to the user process 107. However, the order may be reversed.

On the other hand, when the user's desired file is cached at Step S203, the same process as that of Step S209 and the subsequent steps is performed.

When there is no space area in the cache area at Step S207, the file cache unit 110 ejects the file whose access count is minimum in the cached files and further when the access count is the same, the oldest file among them from the cache memory 113 (Step S211) and the same process as that of Step S208 and the subsequent steps is performed.

When the concerned desired file has a large file capacity, a plurality of files is ejected properly under the same condition. When a file is ejected from the cache memory 113, the property information concerning the file is also deleted from the cache management table by the cache management table renewal unit 114 or it is overwritten later by property information concerning another file.

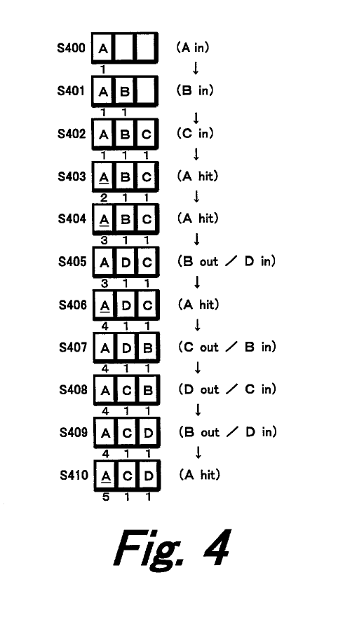

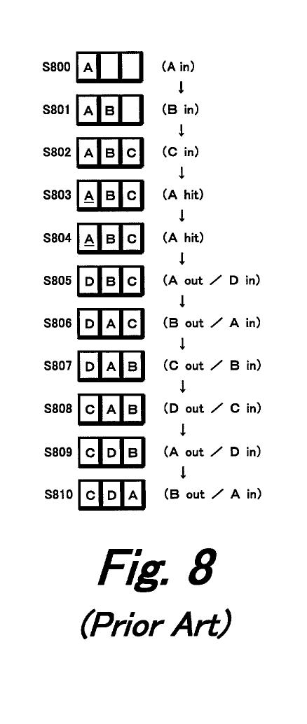

FIG. 4 is a drawing for explaining the cache managing method by the file system 100 relating to this embodiment. Except that the cache managing method is different, the conditions are all the same as those shown in FIG. 8. In FIG. 4, under each slot of the cache memory, the cached access count to a file is indicated.

In this case, when the file D is to be read and cached at Step S405, although the file A is cached first, it is not ejected in consideration of the access count (3 times) thereof and in place of it, among the files B and C having an access count of one time, the file B which is cached first is ejected.

According to this, although the file reading process from the external storage 106 is performed evenly two times respectively for the files B, C, and D, for the file a requiring an access count of 3 times in the conventional LRU system, the access count is reduced to one time by the present invention.

As mentioned above, according to this embodiment, the cache memory is managed on the basis of the access count to a file, thereby a file having a larger access count is always preserved in the cache memory and the file access performance in a condition that access to the same file like the HTTP request is often generated can be improved.

Meanwhile, it is more desirable that the cache management table renewal unit 114 not only renews the contents of the cache management table 111 merely but also has a function to monitor a cached file in response to the newest access time. Namely, the reason is that a file, which is not accessed for many hours though its access count is very large, has a possibility of continuously staying in the cache memory 113.

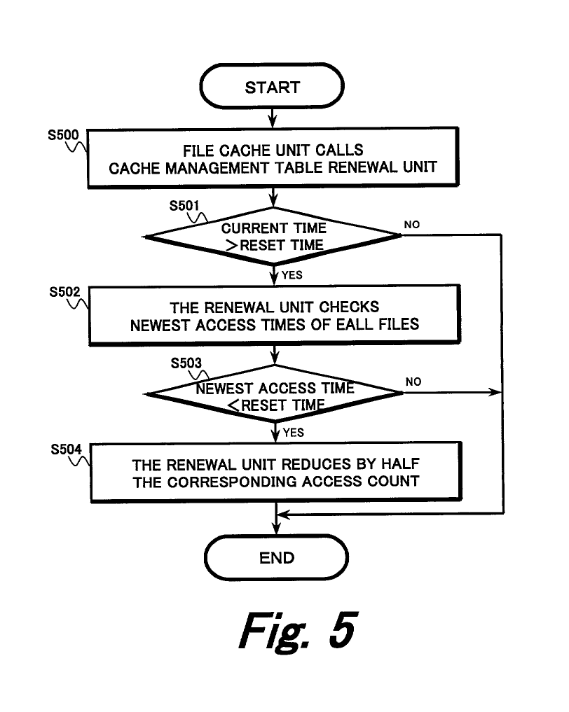

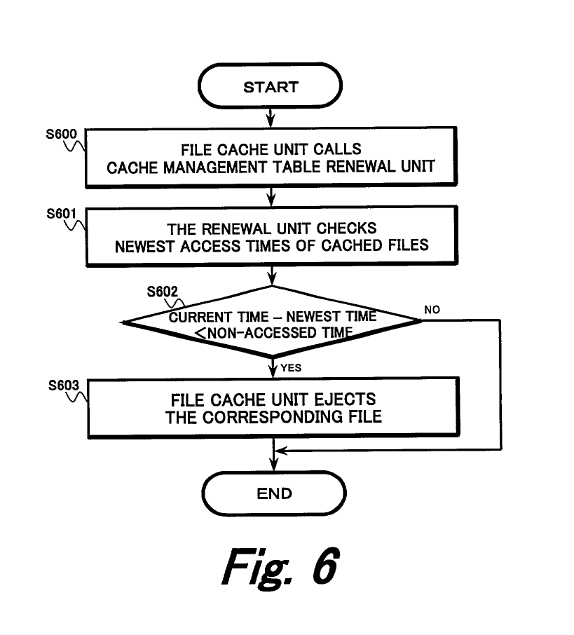

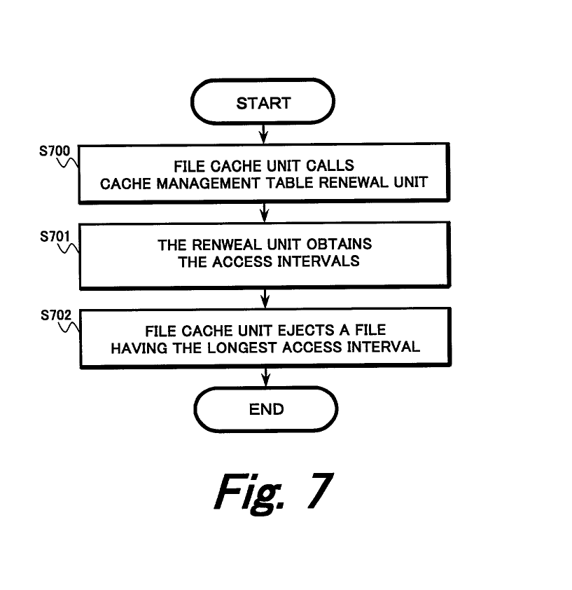

The process flow to be executed by the cache management table renewal unit relating to this embodiment so as to prevent such a condition will be explained by referring to FIGS. 5 to 7. The process flows shown in FIGS. 5 to 7 relate to the ejection method of a file from the cache memory.

Each process flow can operate basically without linking with the flow chart shown in FIG. 3 always. For example, it may be positioned between Step S207 and S211 in Embodiment 1 and between S205 and S206 in Embodiments 2 and 3.

<Embodiment 1>

This embodiment can eject a file having a newest access time earlier than a predetermined time easily from the cache memory by resetting the access count. Therefore, for example, a fixed time is decided as a reset time of the access count of all cached files every day.

Firstly, the file cache unit 110 calls the cache management table renewal unit 114 (Step S500) The called cache management table renewal unit 114 checks whether the current time elapses the reset time (Step S501). When the current time elapses the reset time, the cache management table renewal unit 114 ascertains the newest access time of all the cached files (Step S502) and sets the access count of a file having a newest access time earlier than the reset time (Step S503) to ½ (Step S504). In this case, the access count is set at ½, though it may be cleared.

At Step S501, when the current time is earlier than the reset time or at Step S503, when the newest access time is after the designated reset time, the access time to each a file is not operated.

By doing this, in the next and subsequent file access, a file that the access count is reset at Step S504 is easily ejected from the cache memory 113.

<Embodiment 2>

This embodiment ejects a file, which is not accessed for a given period of time, from the cache memory.

Firstly, the file cache unit 110 calls the cache management table renewal unit 114 (Step S600). The called cache management table renewal unit 114 reads the newest access time of all the cached files from the cache management table 111 (Step S601), compares it with the current time, and checks whether there is a file which is not accessed more than a predetermined period of time (Step S602).

As a result, when there is a file, which is not accessed more than the concerned predetermined period of time, the file cache unit 110 ejects the concerned file from the cache memory 113 (Step S603). By doing this, a space area for a new cache memory can be reserved appropriately in the cache memory 113.

<Embodiment 3>

This embodiment ejects a file that the access interval is longest from the cache memory. In this case, the cache management table 111 preserves the newest access time of each cached file and the access time just prior to it.

Firstly, the file cache unit 110 calls the cache management table renewal unit 114 (Step S700). The called cache management table renewal unit 114 refers to the cache management table 111 for all the cached files and obtains the access interval from the newest access time and the file access time just prior to it (Step S701) and ejects a file that the access interval is longest from the cache memory 113 (Step S702). By doing this, a space area for a new cache memory can be reserved appropriately in the cache memory 113.

In Embodiments 2 and 3 mentioned above, that the files to be ejected are not ejected from the cache memory and the access count is set to ½ or cleared is also effective to prevent those files from staying continuously in the cache memory 113. The essence of the cache managing method of the file system relating to this embodiment caches a file to be accessed in file units in consideration of the access count and last access time and is not limited to the aforementioned combination.

According to each aforementioned embodiment, a file, which is not accessed for many hours though the access count is large, can be prevented from staying in the cache memory for many hours.

In the aforementioned examples, the computer 102 is handled as a WEB server on the network. However, it may be used stand-alone.

The process flow explained in this embodiment and the other embodiments can be realized by either hardware or software. When it is realized by software, middleware such as an OS, database management software, or network software operating on a computer may execute a part of the concerned process flow.

As described above in detail, according to the present invention, the cache memory is managed in response to the access count to a file; thereby a file to which many access requests are given from a user at present is always preserved in the cache memory. By doing this, the cache-hit ratio is improved and as a result, speedup of file access is realized.

What is claimed is:

1. A file system which reads a file from an external storage in response to a request from a user and transfers the read file to the user, comprising:
means for receiving the request from the user and transferring the read file to the user;
means for reading the requested file from the external storage;
a memory;
a file manager which provides the read file to the receiving/transferring means and stores the read file in the memory in units of file;
a table; and
a table manager which records, in the table, an access count to each file stored in the memory; wherein
the file manager, when a requested file is stored in the memory at the time of being received the request, reads the requested file from the memory and provides it to the receiving/transferring means, and, when there is no space for storing the read file in the memory, ejects a file having the least access count among the files stored in the memory.

2. The file system of claim 1, wherein:
the table manager records, in the table, a newest access time to each file stored in the memory; and
the file manager periodically detects a file of which newest access time is before each predetermined time and resets the access count of the detected file.

3. The file system of claim 1, wherein:
the table manager obtains an access interval between the newest access time and a current time for each file stored in the memory, detects a file of which access interval is longer than a predetermined interval, and ejects the detected file from the memory.

4. The file system of claim 1, wherein:
the table management unit obtains an access interval between the newest access time and the second newest access time for each file stored in the memory, detects a file of which the access interval is longest, and ejects the detected file from the memory.

5. The file system of claim 1, wherein:
the memory is a cache memory.

6. A caching method in a file system which reads a file from an external storage in response to a request from a user and transfers the read file to the user, comprising:
receiving the request from the user;
reading the requested file from the external storage;
transferring the read file to the user;
storing the read file in a memory in units of file;
recording, in the table, an access count to each file stored in a memory;
reading the requested file from the memory when a requested file is stored in the memory at the time of being received the request; and
ejecting a file having the least access count among the files stored in the memory when there is no space for storing the read file in the memory.

7. The method of claim 6, further comprising:
recording, in the table, a newest access time to each file stored in the memory; and
periodically detecting a file of which newest access time is before each predetermined time; and
resetting the access count of the detected file.

8. The method of claim 6, further comprising:
obtaining an access interval between the newest access time and a current time for each file stored in the memory;
detecting a file of which access interval is longer than a predetermined interval; and
ejecting the detected file from the memory.

9. The method of claim 6, further comprising:
obtaining an access interval between the newest access time and the second newest access time for each file stored in the memory;
detecting a file of which the access interval is longest; and
ejecting the detected file from the memory.
